(19) United States
(12) Patent Application Publication
(10) Pub. No.: US 2022/0374676 A1
(43) Pub. Date: Nov. 24, 2022

(54) COMPUTING METHOD AND COMPUTING SYSTEM FOR TRANSFORMER MODEL

(71) Applicant: HTC Corporation, Taoyuan City (TW)

(72) Inventors: Tsu-Pei CHEN, Taoyuan City (TW); Zheng-Yu WU, Taoyuan City (TW); Kai-Fu TANG, Taoyuan City (TW); Edward CHANG, Taoyuan City (TW)

(21) Appl. No.: 17/664,660

(22) Filed: May 24, 2022

Related U.S. Application Data
(60) Provisional application No. 63/192,104, filed on May 24, 2021.

(51) Int. Cl. G06N 3/04; G06F 17/16; G06F 7/78

(52) U.S. Cl. CPC G06N 3/04; G06F 17/16; G06F 7/78

(57) ABSTRACT

A computing method, suitable for computing a transformer model, include following steps. An input matrix corresponding to an input sequence of feature vectors is projected into a query matrix according to first learnable weights. The input matrix is projected into a value matrix according to second learnable weights. A factorized matrix is generated by an incomplete Cholesky factorization according to the query matrix and a transpose of the query matrix. An intermediate matrix is calculated according to a product between a transpose of the factorized matrix and the value matrix. An output matrix is calculated according to a product between the factorized matrix (H) and the intermediate matrix.

### CROSS-REFERENCE TO RELATED APPLICATION

This application claims priority to U.S. Provisional Application Ser. No. 63/192,104, filed on May 24, 2021, which is herein incorporated by reference.

### BACKGROUND

### Field of Invention

The disclosure relates to a neural network model. More particularly, the disclosure relates to a computing method for a transformer model.

### Description of Related Art

Machine learning technologies are utilized in many applications, such as artificial intelligence (AI), data mining, auto-pilot, etc. There are various types of neural networks developed to solve different kinds of problems. Among these neural networks, a transformer model is one of the popular neural networks. The transformer model is usually used to solve natural language tasks.

One of the important components of transformer is a self-attention mechanism, which equips the model with the ability of capturing contextual information from the entire sequence and the flexibility of learning representation from diverse data.

### SUMMARY

The disclosure provides a computing method suitable for a transformer model. The computing method includes: projecting an input matrix corresponding to an input sequence of feature vectors, according to first learnable weights, into a query matrix (Q) including query vectors; projecting the input matrix, according to second learnable weights, into a value matrix (V) including value vectors; generating a factorized matrix (H) by an incomplete Cholesky factorization according to the query matrix (Q) and a transpose (Q^{T}) of the query matrix, wherein dimensions of the factorized matrix (H) are smaller than dimensions of the query matrix (Q); calculating an intermediate matrix (H^{T}V) according to a product between a transpose (H^{T}) of the factorized matrix and the value matrix (V); and calculating an output matrix according to a product between the factorized matrix (H) and the intermediate matrix.

The disclosure also provides a computing system, which includes a memory and a processor. The memory is configured to store computer-executable instructions. The processor is coupled with the memory. The processor is configured to execute the computer-executable instructions to implement a transformer model. The transformer model includes an attention layer. The attention layer is configured to: project an input matrix corresponding to an input sequence of feature vectors, according to first learnable weights, into a query matrix (Q) including query vectors; project the input matrix, according to second learnable weights, into a value matrix (V) including value vectors; generate a factorized matrix (H) by an incomplete Cholesky factorization according to the query matrix (Q) and a transpose (Q^{T}) of the query matrix, and dimensions of the factorized matrix are smaller than dimensions of the query matrix; calculate an intermediate matrix according to a product between the transpose of the factorized matrix (H^{T}) and the value matrix (V); and calculate an output matrix according to a product between the factorized matrix (H) and the intermediate matrix.

It is to be understood that both of the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a computing system according to some embodiments in this disclosure.

FIG. 2 is a schematic diagram illustrating a neutral network structure of the transformer model according to some embodiments of the disclosure.

FIG. 3 is an internal structure inside one attention layer with the self-attention mechanism according in some practical cases.

FIG. 4 is an internal structure inside one attention layer with the ICF attention mechanism according in some embodiments of this disclosure.

FIG. 5 is a flow chart illustrating a computing method performed by the attention layer with the ICF attention mechanism in FIG. 4 according to some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

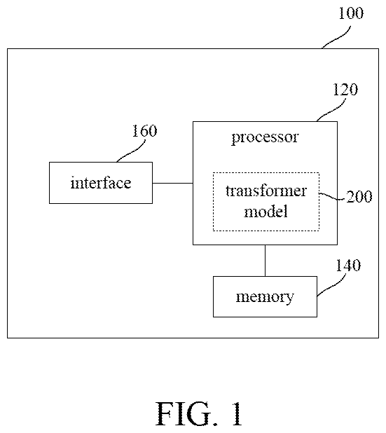

Reference is made to FIG. 1, which is a schematic diagram illustrating a computing system 100 according to some embodiments in this disclosure. In some embodiments, the computing system 100 includes a processor 120, a memory 140 and an interface 160. The computing system 100 is able to compute, train or operate a transformer model 200.

In some embodiments, the memory 140 is configured to store computer-executable instructions, training data (during a training process of the transformer model 200), learnable parameters of the transformer model 200 (after the training process), input data to be processed by the transformer model 200 and/or output data generated by the transformer model 200. The memory 140 may include a random-access memory (RAM) module, a read-only memory (ROM), a flash memory, a hard drive, a cache memory, a static random access memory (SRAM), a dynamic random access memory (DRAM), a non-volatile memory (NVM), a solid state drive (SSD), an optical storage media or any equivalent data storage medium. In some embodiments, the memory 140 may store instructions that are executable by the processor 120 to cause the processor 120 to perform operations corresponding to processes disclosed herein and described in more detail below.

The processor 120 is coupled with the memory 140. The processor 120 is configured to execute the computer-executable instructions to compute, train or operate the transformer model 200. In some embodiments, the transformer model 200 is utilized to perform some various natural language tasks, such as question answering, document classification, name entity extraction, coherence resolution, natural language inference, summarization and translation.

In some embodiments, the processor 120 may include a graphics processing unit (GPU), an application specific integrated circuit (ASIC), a field programmable gate array (FPGA), a tensor processing unit (TPU), a digital signal processor (DSP), a single-instruction multiple-data (SIMD) processor and/or any equivalent processing circuit. Generally, such processors may accelerate various computing tasks associated with evaluating neural network models (e.g., training, prediction, preprocessing, and/or the like) by an order of magnitude or more in comparison to a general-purpose center processing unit (CPU).

The interface 160 is coupled with the processor 120. The interface 160 can include a keyboard, a displayer, a network transceiver, a connection port (e.g., a USB connection port), a touch panel or any equivalent input/output components. A user or an external device can provide an input to the transformer model 200 or receive an output result from the transformer model 200 through the interface 160.

In an example, when the transformer model 200 is configured to perform a translation task, a user can input an article in a first language, such as a financial report in Mandarin, and the processor 120 will feed this financial report as an input sequence to the transformer model 200. In some embodiments, the input sequence comprises characters or words in a first language (e.g., Mandarin). The transformer model 200 is configured to translate the financial report in Mandarin into another language and generates an output sequence. The output sequence includes characters or words in a second language (e.g., English). In this case, the transformer model 200 is configured to translate the input sequence into the output sequence. The transformer model 200 is not limited to perform a translation task.

In some embodiments, the transformer model 200 is configured to perform a topic extraction task. In this case, the input sequence includes an article or a document, and the transformer model 200 is configured to generate an output sequence which includes a summary corresponding to the article or the document. For example, the transformer model 200 is configured to generate the output sequence “inflation program in Asia”, which corresponds to the input sequence including the financial report. In some other cases, the output sequence generated by the transformer model 200 can be a classification result, an answer to a question or a title corresponding to the input sequence. The transformer model 200 is configured to extract, identify or generate the output sequence from the input sequence.

In some embodiments, to achieve aforesaid tasks (translation, classification or answering a question), the transformer model 200 in this disclosure utilizes an incomplete Cholesky factorization (ICF) attention mechanism, which equips the transformer model 200 with the ability of capturing contextual information from the whole input sequence and the flexibility of learning representation from diverse data. The incomplete Cholesky factorization (ICF) attention mechanism discussed in the disclosure is approximate to a self-attention mechanism. The self-attention mechanism is a type of all-to-all attention (all attention vectors are correlated to all attention vectors). In this case, a transformer model with the self-attention mechanism occupies relatively large memory storage (for storing the vectors used in the all-to-all attention). While a length of an input sequence increasing, the memory usage of the self-attention mechanism grows quadratically. The quadratically-growing memory usage becomes a resource bottleneck during training. Consequently, it requires a huge number of resources and time to pretrain a transformer model with the self-attention mechanism, and it also limits the transformer model with the self-attention mechanism to handle with a longer input sequence such as a high-resolution figure and/or a long document.

In some embodiments, the transformer model 200 in this disclosure operates with the ICF attention mechanism, which can generate a result approaching to the self-attention mechanism. The transformer model 200 with the ICF attention mechanism is able to approximate all-to-all attention with linear memory complexity. In some embodiments, the transformer model 200 with the ICF attention mechanism is able to retain a flexibility of the transformer model 200 and solve aforesaid quadratic scaling issue.

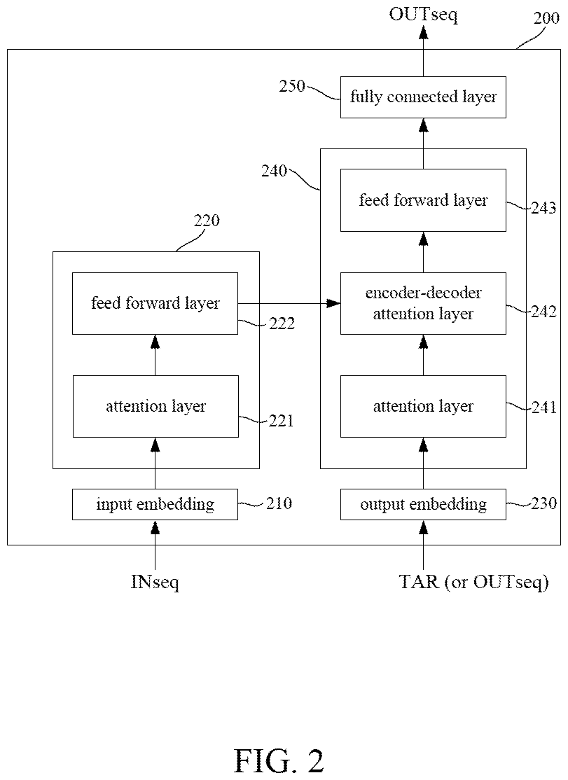

Reference is further made to FIG. 2, which is a schematic diagram illustrating a neutral network structure of the transformer model 200 according to some embodiments of the disclosure. As shown in FIG. 2, the transformer model 200 includes an input embedding module 210, an encoder module 220 and a decoder module 240.

The input embedding module 210 is configured to convert an input sequence INseq into an input representation. In some embodiments, the input embedding module 210 is configured to tokenize the input sequence (e.g., a text sequence including a series of words) and map each token to a vector representation in a multidimensional vector space. For example, a token corresponding to a word may be mapped to a 100-dimensional vector representation of the word.

In a demonstrational case, it is assumed that the input sequence is “today is a good day” with a sequence length of “5”. The first word “today” in the input sequence is mapped to one vector representation in a 100-dimensional vector representation (e.g., a 1×100 matrix). The second word “is” in the input sequence is mapped to another vector representation in a 100-dimensional vector representation. In this case, the whole input sequence with five words is represented as a 5×100 input representation. Similarly, if the input sequence includes 2048 words, the input sequence will be represented as a 2048×100 input representation.

The encoder module 220 is configured to generate an encoded representation based on the input representation corresponding to the input sequence INseq. The decoder module 240 is configured to generate or predicts an output sequence OUTseq based on the encoded representation generated by the encoder module 220.

In some embodiments, the transformer model 200 may include a fully connected layer 250, which is coupled with the decoder module 240. The fully connected layer 250 is configured to generate an output sequence OUTseq according to an output matrix generated by the decoder module 240.

In some embodiments, the transformer model 200 may include an output embedding module 230, which is configured to generate an output representation based on the output sequence OUTseq or a target sequence TAR. In general, the output embedding module 230 may perform an embedding operation based on the output sequence OUTseq, and the embedding operation is similar to aforesaid embedding operation performed by the input embedding module 210 based on the input sequence INseq.

As shown in FIG. 2, in some embodiments, the encoder module 220 includes an attention layer 221 and a feed forward layer 222, and the decoder module 240 includes an attention layer 241, an encoder-decoder attention layer 242 and a feed forward layer 243. Among these layers, the attention layer 221, the attention layer 241 and the encoder-decoder attention layer 242 are utilized to find out attention relationships between different tokens (e.g., corresponding words in the input sequence or in the output sequence), and the feed forward layer 222 and the feed forward layer 243 are utilized to generate learnable parameters of the transformer model 200.

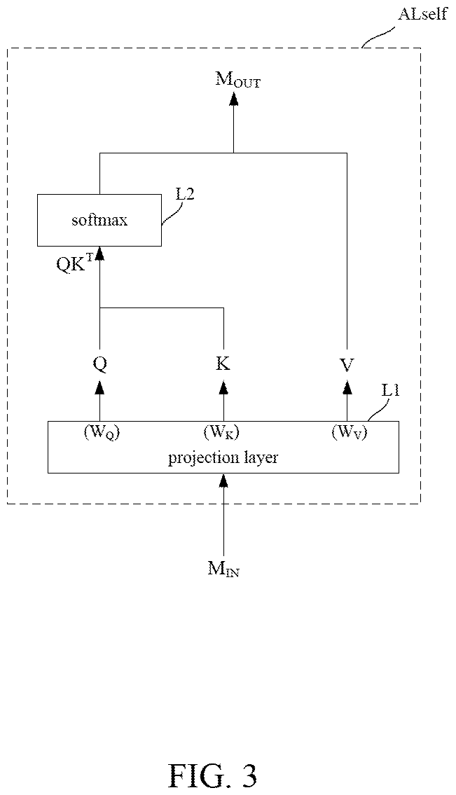

Reference is further made to FIG. 3, which is an internal structure inside one attention layer ALself with the self-attention mechanism according in some practical cases. In some practical cases, the attention layer ALself with the self-attention mechanism can be utilized in at least one (or each one) of the attention layer 221, the attention layer 241 and the encoder-decoder attention layer 242. In some embodiments, the attention layer ALself is implemented by instruction programs executed by the processor 120 shown in FIG. 1.

As shown in FIG. 3, the attention layer ALself with the self-attention mechanism includes a projection layer L1 and a softmax layer L2.

The attention layer ALself with the self-attention mechanism allows a token to attend to all the tokens of the sequence and incorporate the information of other tokens. An input matrix M_{IN} corresponding to the input sequence INseq is processed by the projection layer L1 through three linear projections (by applying learnable weights W_{Q}, W_{K}, and W_{V}) to emit query vectors, key vectors and value vectors respectively.

In some embodiments, dimensions of the input matrix M_{IN} are n×d, in which n is a sequence length of the input sequence INseq, and d is a dimension value of the feature vectors in the input sequence INseq. For example, when the input sequence INseq includes 2048 words and each word in the input sequence INseq is mapped to one vector representation in a 100-dimensional vector representation, the input matrix M_{IN} will be a 2048×100 matrix (n=2048, d=100). For the reasons of parallelization, the query vectors generated by the projection layer L1 are packed into a query matrix Q with n×d dimensions. Similarly, the key vectors and value vectors are packed into a key matrix K with n×d dimensions and a value matrix V key n×d respectively.

An output matrix M_{OUT} of the attention layer ALself with the self-attention mechanism is defined as:

$$M\_OUT = self\_attention ( Q , K , V ) = softmax ( \frac{Q {K}^{T}}{\sqrt{d}} ) V \qquad equation ( 1 )$$

In the equation (1), an attention matrix QK^{T} is a product between the query matrix Q and a transpose K^{T} of the key matrix K. The attention matrix QK^{T} preserves the attention values of all the pairs of tokens and correlates all the tokens of the sequence. The attention matrix QK^{T} is divided by a scaling factor \sqrt{d}, and passed into the softmax layer L2. An output,

$$softmax ( \frac{Q {K}^{T}}{\sqrt{d}} ) ,$$

of the softmax layer L2 representing the attention weights of the queries and all the keys, and the output of the softmax layer L2 is used to linearly combine with the value matrix V to generate the output matrix M_{OUT}.

During aforesaid calculations for generate the output matrix MOUT, the softmax layer L2 is calculated according to the attention matrix QK^{T}. In this case, the query matrix Q is a n×d matrix; and the transpose K^{T} of the key matrix K is a d×n matrix; and the attention matrix QK^{T} is a n×n matrix. While the length, n, of the sequence increasing, the memory usage of the attention matrix QK^{T} grows quadratically, which becomes a resource bottleneck during training.

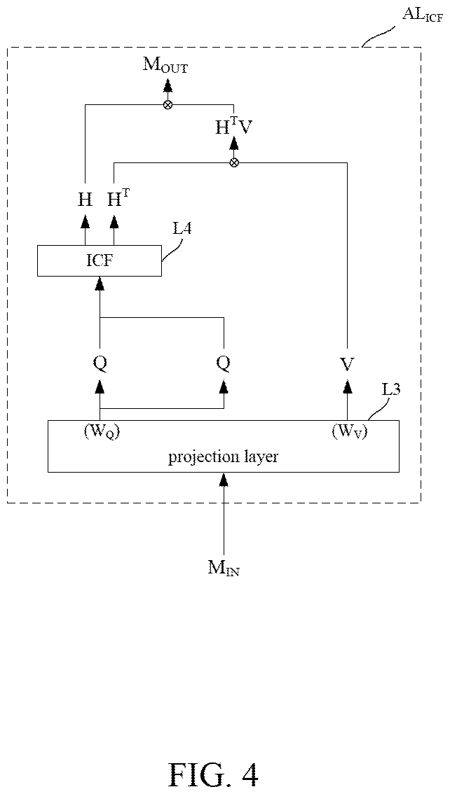

Reference is further made to FIG. 4, which is an internal structure inside one attention layer AL_{ICF} with the ICF attention mechanism according in some embodiments of this disclosure. In some embodiments, the attention layer AL_{ICF} with the ICF attention mechanism can be utilized in at least one (or each one) of the attention layer 221, the attention layer 241 and the encoder-decoder attention layer 242. In some embodiments, the attention layer AL_{ICF} is implemented by instruction programs executed by the processor 120 shown in FIG. 1.

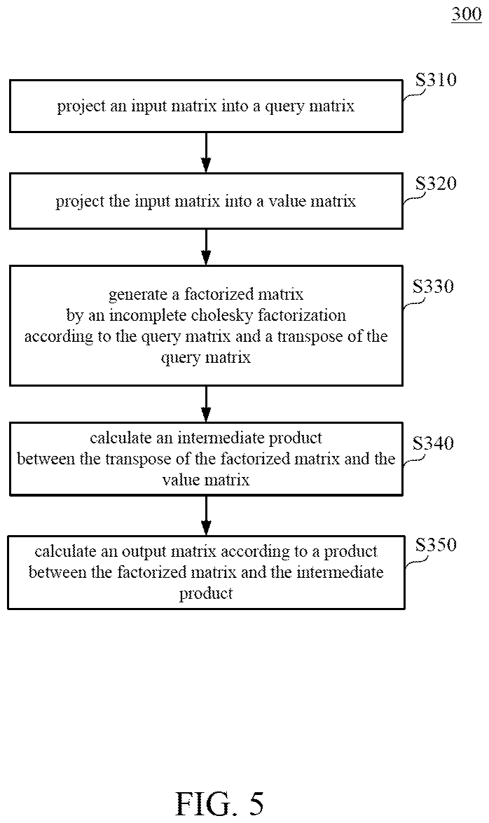

As shown in FIG. 4, the attention layer AL_{ICF} with the ICF attention mechanism includes a projection layer L3 and an incomplete Cholesky factorization (ICF) function layer L4. Reference is further made to FIG. 5, which is a flow chart illustrating a computing method 300 performed by the attention layer AL_{ICF} with the ICF attention mechanism in FIG. 4 according to some embodiments of the disclosure.

As shown in FIG. 4 and FIG. 5, in step S310 of the computing method 300, the projection layer L3 projects the input matrix M_{IN} corresponding to the input sequence INseq (referring to FIG. 2) of feature vectors, according to first learnable weights W_{Q}, into a query matrix Q. The query matrix Q includes query vectors corresponding to all tokens of the feature vectors (e.g., words from the input sequence INseq) in the input matrix M_{IN}.

In some embodiments, dimensions of the input matrix M_{IN} are n×d, in which n is a sequence length of the input sequence INseq, and d is a dimension value of the feature vectors in the input sequence INseq. In some embodiments, the query vectors generated by the projection layer L3 are packed into a query matrix Q with n×d dimensions. For example, when the input sequence INseq includes 2048 words and each word in the input sequence INseq is mapped to one vector representation in a 100-dimensional vector representation, the input matrix M_{IN} will be a 2048×100 matrix (n=2048, d=100), and the query matrix Q will also be a 2048×100 matrix.

As shown in FIG. 4 and FIG. 5, in step S320 of the computing method 300, the projection layer L3 projects the input matrix M_{IN} corresponding to the input sequence INseq (referring to FIG. 2) of feature vectors, according to second learnable weights W_{V}, into a value matrix V. The value matrix V includes value vectors corresponding to all tokens of the feature vectors (e.g., words from the input sequence INseq) in the input matrix M_{IN}.

In some embodiments, the query vectors generated by the projection layer L3 are packed into the value matrix V with n×d dimensions. For example, when the input matrix M_{IN} is a 2048×100 matrix (n=2048, d=100), and the value matrix V will also be a 2048×100 matrix.

As shown in FIG. 4 and FIG. 5, in step S330 of the computing method 300, the ICF function layer L4 is configured to generate a factorized matrix H by an incomplete Cholesky factorization according to the query matrix Q and a transpose Q^{T} of the query matrix Q (generated by the projection layer L3). In some embodiments, dimensions of the factorized matrix H are smaller than dimensions of the query matrix Q. Further details about how to generate the factorized matrix H are discussed in following paragraphs.

In step S330, the ICF function layer L4 is configured to calculate the factorized matrix H and a transpose H^{T} of the factorized matrix H, and to make a product HH^{T} (between the factorized matrix H and the transpose H^{T}) approximate to an exponential function of a shared-QK attention matrix (QQ^{T}).

The shared-QK attention matrix QQ^{T} is defined as a product between the query matrix Q and a transpose Q^{T} of the query matrix Q. As shown in FIG. 4, the attention layer AL_{ICF} does not generate a key matrix (referring to the key matrix K in FIG. 3). In the attention layer AL_{ICF} shown in FIG. 4, the key values are defined as the same as the query values. In this case, the shared-QK attention matrix QQ^{T} will be a symmetric and positive semi-definite matrix. In some embodiments, the performance with shared-QK attention is competitive with the non-shared one (e.g., the self-attention) in some applications, such as speaker classification, frame-level speaker classification, and phoneme classification. It is noticed that dimensions of the shared-QK attention matrix QQ^{T} are still n×n, and if the shared-QK attention matrix QQ^{T} is directly used to calculate the output matrix M_{OUT}, it will occupy relatively large memory storage similar to the self-attention mechanism.

In some embodiments, the ICF function layer L4 is configured to calculate the factorized matrix H and a transpose H^{T} of the factorized matrix H, and the ICF function can make sure the product HH^{T} being approximate to an exponential function of the shared-QK attention matrix QQ^{T}, such that the factorized matrix H and the transpose H^{T} can be used as a substitute of the shared-QK attention matrix QQ^{T}.

For the purpose of explaining the matrix approximation, aforesaid equation (1) is rewritten, replacing K^{T} with Q^{T} (shared-QK) and expending according to a definition of softmax function, into following equation (2):

$${M}_{O U T} = softmax ( \frac{Q {Q}^{T}}{\sqrt{d}} ) V \to {M}_{O U T} = [ exp ( {QQ}^{T} ) exp ( {QQ}^{T} ) \vec{1} ] V \qquad equation ( 2 )$$

In the equation (2), exp(QQ^{T}) is an exponential function of the shared-QK attention matrix QQ^{T}; [symbol] denotes element-wise division; \vec{1} denotes an all-ones vector; the scaling factor \sqrt{d} is omitted in the equation (2) for simplicity.

It is noticed that the exp(QQ^{T}) is a symmetric and positive definite matrix (i.e., SPD matrix). Incomplete Cholesky factorization (ICF) can be used to approximate a symmetric and positive definite (SPD) matrix in n×n dimensions by a smaller factorized matrix H in n×p dimensions, wherein p<<n. Because exp(QQ^{T}) satisfies a requirement of SPD matrix, the ICF function can derive the factorized matrix H and the transpose H^{T} to approximate the hadamard exponential function of the shared-QK attention matrix QQ^{T}.

The parameter p is a dynamic variable utilized by the incomplete Cholesky factorization for approximation. In some embodiments, the parameter p is set to be equal to or smaller than d. When p is set to be equal to d, the factorized matrix H will be efficient in down-sizing the factorized matrix H and also keeping the most features in the original all-to-all attention.

In some other embodiments, the parameter p is set to be equal to or smaller than a rank of the shared-QK attention matrix (QQ^{T}). If the parameter p is larger than the rank of the shared-QK attention matrix (QQ^{T}), the factorized matrix H in this case will include all-zero row, which carries no information and occupies unnecessary memory.

As mentioned above, the dimensions of the query matrix (Q) are n×d. In some embodiments, dimensions of the factorized matrix H generated by the ICF layer L4 are n×p, and p<<n. In which, p is a parameter corresponding to an iteration count in the incomplete Cholesky factorization. The factorized matrix H and the transpose H^{T} of the factorized matrix are utilized by the transformer model 200 to replace the shared-QK attention matrix while calculating the output matrix M_{OUT}.

After the derivation of the factorized matrix H and the transpose H^{T} by the ICF function, the product of these two matrices (HH^{T}) is used to substitute the exponential function of the shared-QK attention matrix exp(QQ^{T}) in aforesaid equation (2), and define an output matrix M_{OUT} of the attention layer AL_{ICF} shown in FIG. 4 as:

M_{OUT}=ICFattetion(Q,V)=(HH^{T} [symbol] HH^{T}\vec{1})V=H(H^{T}V) [symbol] H(H^{T}\vec{1}) equation (3)

In step S340, the attention layer AL_{ICF} executed by the processor is configured to calculate an intermediate matrix H^{T}V according to a product between the transpose H^{T} of the factorized matrix H and the value matrix V.

In step S350, the attention layer AL_{ICF} executed by the processor is configured to calculate the output matrix M_{OUT} based on the equation (3). In other words, the output matrix M_{OUT} is calculated according to a product between the factorized matrix H and the intermediate matrix H^{T}V.

In some embodiments, dimensions of the intermediate matrix H^{T}V are smaller than dimensions of the shared-QK attention matrix QQ^{T}. As discussed above, dimensions of the query matrix Q are n×d; dimensions of the transpose of the query matrix Q^{T} are d×n; and dimensions of the shared-QK attention matrix QQ^{T} are n×n; dimension of the transpose H^{T} of the factorized matrix H are p×n; dimension of the value matrix V are n×d; and dimension of the intermediate matrix H^{T}V are p×d.

In most of cases, when the input sequence includes a long document (i.e., n is relatively large), the sequence length n will be far greater than p and d (i.e., n>>p and n>>d). For example, when the long document includes 3000 words or above, the sequence length n will reach 3000 or above. Accordingly, the dimensions of the intermediate matrix H^{T}V will be far smaller than the dimensions of the shared-QK attention matrix QQ^{T}.

In the embodiments of the attention layer ALself with the self-attention mechanism shown in FIG. 3, the output matrix M_{OUT} is calculated based on an exponential function exp(QK^{T}) of the attention matrix QK^{T}, and a complexity of this exponential function will be O(n²). While a length “n” of the input sequence INseq increasing, the memory usage of the self-attention mechanism grows quadratically.

In the embodiments of the attention layer AL_{ICF} with the ICF attention mechanism shown in FIG. 4, dimensions of the intermediate matrix H^{T}V are p×d, the memory storage used in calculating of step S340 has a complexity of O(np). In step S350, the calculating is performed between the factorized matrix H (in dimensions of n×p) and the intermediate matrix H^{T}V (in dimensions of p×d), such that the memory storage used in calculating of step S350 also has a complexity of O(np). Therefore, the memory storage used in calculating the attention layer AL_{ICF} has a linear relationship relative to the length of the input sequence INseq.

As shown in FIG. 2 and FIG. 4, the output matrix M_{OUT} of one attention layer can be an input matrix to another attention layer. For example, the output matrix generated by the attention layer 241 can be the input matrix to the encoder-decoder attention layer 242.

In some embodiments, the output matrix M_{OUT} of one attention layer can be transmitted to the fully connected layer 250 as shown in FIG. 2, the fully connected layer 250 is configured to generate the output sequence OUTseq according to the output matrix M_{OUT}.

By using the attention layer AL_{ICF} with the ICF attention mechanism, the transformer model 200 is able to process the input sequence with a longer length. It will be very useful when the transformer model 200 is utilized to translate a paper, a magazine or a long article, because the transformer model 200 is able to obtain an attention matrix of the whole input sequence and generating the output accordingly, without cutting the long input sequence into several pieces.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A computing method, suitable for a transformer model, the computing method comprising:
projecting an input matrix corresponding to an input sequence comprising feature vectors, according to first learnable weights, into a query matrix (Q) comprising query vectors;
projecting the input matrix, according to second learnable weights, into a value matrix (V) comprising value vectors;
generating a factorized matrix (H) by an incomplete Cholesky factorization according to the query matrix (Q) and a transpose (Q^{T}) of the query matrix, wherein dimensions of the factorized matrix are smaller than dimensions of the query matrix;
calculating an intermediate matrix (H^{T}V) according to a product between a transpose (H^{T}) of the factorized matrix and the value matrix (V); and
calculating an output matrix according to a product between the factorized matrix and the intermediate matrix.

2. The computing method of claim 1, wherein dimensions of the input matrix are n×d, n is a sequence length of the input sequence, and d is a dimension value of the feature vectors in the input sequence.

3. The computing method of claim 2, wherein the incomplete Cholesky factorization is configured to make a product between the factorized matrix and the transpose of the factorized matrix approximate to an exponential function of a shared-QK attention matrix (QQ^{T}), the dimensions of the query matrix (Q) are n×d, the dimensions of the factorized matrix (H) are n×p, p is a parameter corresponding to an iteration count in the incomplete Cholesky factorization, the factorized matrix (H) and the transpose (H^{T}) of the factorized matrix are utilized by the transformer model to replace the shared-QK attention matrix while calculating the output matrix.

4. The computing method of claim 3, wherein the parameter p is utilized by the incomplete Cholesky factorization for approximation.

5. The computing method of claim 4, wherein the parameter p is set to be equal to or smaller than d.

6. The computing method of claim 4, wherein the parameter p is set to be equal to or smaller than a rank of the shared-QK attention matrix (QQ^{T}).

7. The computing method of claim 3, wherein the shared-QK attention matrix (QQ^{T}) is defined according to a product between the query matrix (Q) and a transpose of the query matrix (Q^{T}), dimensions of the intermediate matrix (H^{T}V) are smaller than dimensions of the shared-QK attention matrix (QQ^{T}).

8. The computing method of claim 7, wherein dimensions of the transpose (Q^{T}) of the query matrix are d×n, dimensions of the shared-QK attention matrix (QQ^{T}) are n×n, the dimensions of the intermediate matrix (H^{T}V) are p×d.

9. The computing method of claim 1, wherein the output matrix is calculated as:
H(H^{T}V) [symbol] H(H^{T}\vec{1})
wherein [symbol] denotes element-wise division, \vec{1} denotes an all-ones vector, H denotes the factorized matrix, H^{T} denotes the transpose of the factorized matrix, H^{T}V denotes the intermediate matrix.

10. The computing method of claim 1, further comprising:
generating an output sequence by a fully connected layer according to the output matrix.

11. The computing method of claim 10, wherein the input sequence comprises characters or words in a first language, the output sequence comprises characters or words in a second language, the transformer model is configured to translate the input sequence into the output sequence.

12. The computing method of claim 10, wherein each of the input sequence and the output sequence comprises characters or words, the input sequence comprises an article or a document, the output sequence comprises a summary, a classification result, an answer to a question or a title corresponding to the input sequence, the transformer model is configured to extract, identify or generate the output sequence from the input sequence.

13. A computing system, comprising:
a memory, configured to store computer-executable instructions; and
a processor coupled with the memory, the processor is configured to execute the computer-executable instructions to implement a transformer model, the transformer model comprising an attention layer, wherein the attention layer is configured to:
project an input matrix corresponding to an input sequence comprising feature vectors, according to first learnable weights, into a query matrix (Q) comprising query vectors;
project the input matrix, according to second learnable weights, into a value matrix (V) comprising value vectors;
generate a factorized matrix (H) by an incomplete Cholesky factorization according to the query matrix (Q) and a transpose (Q^{T}) of the query matrix, wherein dimensions of the factorized matrix are smaller than dimensions of the query matrix;
calculate an intermediate matrix (H^{T}V) between the transpose (H^{T}) of the factorized matrix and the value matrix (V); and
calculate an output matrix according to a product between the factorized matrix and the intermediate matrix.

14. The computing system of claim 13, wherein dimensions of the input matrix are n×d, n is a sequence length of the input sequence, and d is a dimension value of the feature vectors in the input sequence.

15. The computing system of claim 14, wherein the incomplete Cholesky factorization is configured to make a product between the factorized matrix (H) and the transpose of the factorized matrix (H^{T}) approximate to an exponential function of a shared-QK attention matrix (QQ^{T}), the dimensions of the query matrix (Q) are n×d, the dimensions of the factorized matrix (H) are n×p, p is equal to or smaller than d, p is a parameter corresponding to an iteration count in the incomplete Cholesky factorization, the factorized matrix (H) and the transpose (H^{T}) of the factorized matrix are utilized by the transformer model to replace the shared-QK attention matrix while calculating the output matrix.

16. The computing system of claim 15, wherein the shared-QK attention matrix (QQ^{T}) is defined according to a product between the query matrix (Q) and a transpose (Q^{T}) of the query matrix, dimensions of the intermediate matrix (H^{T}V) are smaller than dimensions of the shared-QK attention matrix (QQ^{T}).

17. The computing system of claim 16, wherein dimensions of the transpose (Q^{T}) of the query matrix are d×n, dimensions of the shared-QK attention matrix (QQ^{T}) are n×n, the dimensions of the intermediate matrix (H^{T}V) are p×d.

18. The computing system of claim 13, wherein the transformer model further comprises a fully connected layer, wherein the fully connected layer is configured to generate an output sequence according to the output matrix.

19. The computing system of claim 18, wherein the input sequence comprises characters or words in a first language, the output sequence comprises characters or words in a second language, the transformer model is configured to translate the input sequence into the output sequence.

20. The computing system of claim 18, wherein each of the input sequence and the output sequence comprises characters or words, the input sequence comprises an article or a document, the output sequence comprises a summary, a classification result, an answer to a question or a title corresponding to the input sequence, the transformer model is configured to extract, identify or generate the output sequence from the input sequence.
